(19) United States
(12) Patent Application Publication
(10) Pub. No.: US 2014/0229402 A1
(43) Pub. Date: Aug. 14, 2014

(54) Funding and Distribution of Income Stream Payments for a Period Associated with the Longevity of Participant Individuals

(71) Applicant: Bruno CARON, New York, NY (US)

(72) Inventor: Bruno CARON, New York, NY (US)

(21) Appl. No.: 14/178,575

(22) Filed: Feb. 12, 2014

Related U.S. Application Data
(60) Provisional application No. 61/763,559, filed on Feb. 12, 2013.

(51) Int. Cl. G06Q 40/06

(52) U.S. Cl. CPC G06Q 40/06
USPC 705/36 R

(57) ABSTRACT

The present invention relates to a retirement system that addresses longevity risk of selected individuals having common mortality risks. The individuals participate in an investment group and the investment is typically grown in an accumulation phase. Thereafter, payments are distributed to surviving participants at a rate and for a number of periods calculated with respect to the longevity experience and expectations of the participants and the achieved and projected investment returns.

### BACKGROUND OF THE INVENTION

The present invention relates to a retirement system that addresses longevity risk of selected individuals having common mortality risks. The individuals participate in an investment group and the investment is typically grown in an accumulation phase. Thereafter, payments are distributed to surviving participants at a rate and for a number of periods calculated with respect to the longevity experience and expectations of the participants and the achieved and projected investment returns.

### SUMMARY OF THE INVENTION

According to a first embodiment of the invention, there is provided a method for distributing an income stream of payments to a group of participant individuals for an indefinite period associated with the longevity of the participants, the method comprising:
providing one or more computers or one or more computer servers, the one or more computers or one or more computer servers having a processor and memory storage with instructions which when executed by the processor perform predetermined functions;
providing a database stored on the memory storage of the at least one or more computers or one or more computer servers;
in an establishment function phase:
   collecting information for storage in the database relating to a plurality of potential participants, the information including mortality criteria;
   identifying, by the one or more computers or one or more computer servers, from the information collected, common mortality criteria and/or common expected mortality calculated from some or all of the mortality criteria relating to some or all of the potential participants indicating a substantially equivalent mortality risk;
   defining, by the one or more computers or one or more computer servers, from some or all the identified common mortality criteria and/or the common expected mortality, requirements for inclusion of potential participants in one or more substantially homogeneous mortality risk groups;
   identifying, by the one or more computers or one or more computer servers, a plurality of participants having a substantially equivalent mortality risk as determined by meeting the requirements for inclusion in the one or more groups;
   forming one or more groups of some or all of the identified participants, the matching of the participant in any group being selected by the participant or on behalf of the participant;
   establishing a group investment fund, the investment fund being the aggregation of investment payments received from or on behalf of each participant in the group;
   investing some or all of the investment fund in an asset allocation portfolio in accordance with predetermined investment guidelines intended to grow the investment fund; and
in a distribution phase:
   distributing a portion of the investment fund as payments at predetermined distribution periods, the portion being made available for distribution payments at the completion of any period being calculated according to a predefined actuarially fair calculation agreed between the participants;
      wherein some or all of the longevity risk is transferred to the group of participants and an income stream of payments to the participants is made available for as long as they live or until there is only a predetermined number of survivors remaining from the original group or where a predefined time has elapsed after formation of the group or after the occurrence of another predefined circumstance.

Generally, mortality criteria relates to the potential participants' age, gender and health condition; but may include other criteria considered relevant to expected mortality, including living habits, type of employment and the like.

Preferably, in an accumulation phase, the asset allocation portfolio is invested for a predetermined accumulation period prior to the initiation of the distribution phase. Typically, the participants will be afforded the right to leave the group voluntarily at any time during the accumulation phase. Preferably, a surrender charge will be deducted from the participant's share in the investment fund for such early withdrawals, and typically the charge will be significant in order to dissuade withdrawals. In the event of death in the accumulation phase, the participants may have agreed that a death charge or no charge be applied. Generally, the deducted charge is retained in the investment fund for the benefit of the remaining participants; given this benefit, participants may consider acceptance at group formation of a high surrender and/or death charge to be a desirable feature to encourage ongoing participation and/or as a source of investment gain. Typically, a death charge would be less than a surrender charge, but could be higher or even complete forfeiture as agreed between the participants.

In the distribution phase, payments are generally made only to any surviving participants remaining. However, the participants may have agreed that the payments still be made to survivors and beneficiaries of survivors for a predetermined initial period after the accumulation period.

Typically, the predefined actuarially fair calculation accounts for variations in the investment results achieved, in anticipated future investment returns, in the group's mortality experience and in expected future mortality risk. In the event that the income stream of payments is to be made after the effluxion of predefined time, the time may be determined based on the age of the group or the period since group formation.

Typically some or all of the investment risk associated with the investment fund is transferred to the group of participants.

Generally, the aim is to maintain distribution payments as stable as possible, recognizing the reliance participants may place on the income stream as a hedge against depletion of financial recourses in retirement as a result of longevity. Preferably, a cushion account is provided as side fund allocated within the investment fund from which distribution payments are not initially withdrawn, being designed to lower the risk of decreased future distribution payments. The buffer held in the cushion account is reduced over time until a predetermined period is completed since group formation or after predefined circumstances have reduced in effect; so more of the buffer becomes available for distribution over time.

Fees may be payable to third parties relating to the formation and/or management of the investment fund and for the calculation and/or management of the distributed income stream of payments. These fees are typically deducted from the funds available in the investment fund, but may also be deducted in whole or in part from the payments made to the participants.

According to a second embodiment of the invention, there is provided a retirement product for the provision of a stream of payments to a group of participant individuals for an indefinite period associated with the longevity of the participants, the product comprising:
one or more computers or one or more computer servers, the one or more computers or one or more computer servers having a processor and memory storage with instructions which when executed by the processor perform predetermined functions;
a database stored on the memory storage of the at least one or more computers or one or more computer servers, the database being operable to receive information relating to a plurality of potential participants, the information including mortality criteria, the database having means for identifying, common mortality criteria and/or common expected mortality calculated from some or all of the mortality criteria relating to some or all of the potential participants thereby indicating a substantially equivalent mortality risk;
a definition function, performed by the one or more computers or one or more computer servers that defines from some or all the identified common mortality criteria and/or the common expected mortality, requirements for inclusion of potential participants in one or more substantially homogeneous mortality risk groups and thereby operable to identify a plurality of participants having a substantially equivalent mortality risk as determined by meeting the requirements for inclusion in the one or more groups;
one or more groups, operable to be formed from some or all of the identified participants, the matching of the participant in any group being operable to be selected by the participant or on behalf of the participant;
a group investment fund, operable to be funded with the aggregation of investment payments received from or on behalf of each participant in the group and operable to invest some or all of the investment fund in an asset allocation portfolio in accordance with predetermined investment guidelines intended to grow the investment fund; and
payment distribution means, operable to distribute a portion of the investment fund as payments at predetermined distribution periods, the portion being made available for distribution payments at the completion of any period being calculated according to a predefined actuarially fair calculation agreed between the participants;
   wherein in operation some or all of the longevity risk is operable to be transferred to the group of participants and an income stream of payments to the participants is made available for as long as they live or until there is only a predetermined number of survivors remaining from the original group or where a predefined time has elapsed after formation of the group or after the occurrence of another predefined circumstance.

According to a third aspect of the invention there is provided a system for the provision of a stream of payments to a group of participant individuals for an indefinite period associated with the longevity of the participants, the system comprising:
one or more computers or one or more computer servers, the one or more computers or one or more computer servers having a processor and memory storage with instructions which when executed by the processor perform predetermined functions;
a database stored on the memory storage of the at least one or more computers or one or more computer servers;
an information receiving function module, operable to receive information on the database relating to a plurality of potential participants, the information including mortality criteria, the database identifying common mortality criteria and/or common expected mortality calculated from some or all of the mortality criteria relating to some or all of the potential participants thereby indicating a substantially equivalent mortality risk;
a mortality assessment function module, performed by the one or more computers or one or more computer servers, and defining, from some or all the identified common mortality criteria and/or the common expected mortality, requirements for inclusion of potential participants in one or more substantially homogeneous mortality risk groups and thereby operable to identify a plurality of participants having a substantially equivalent mortality risk as determined by meeting the requirements for inclusion in the one or more groups;
a group formation function module, operable to form one or more groups from some or all of the identified participants, the matching of the participant in any group being operable to be selected by the participant or on behalf of the participant;
an investment module, operable to form a group investment fund funded with the aggregation of investment payments received from or on behalf of each participant in the group and operable to invest some or all of the investment fund in an asset allocation portfolio in accordance with predetermined investment guidelines intended to grow the investment fund; and
a distribution module, operable to distribute a portion of the investment fund as payments at predetermined distribution periods, the portion being made available for distribution payments at the completion of any period being calculated according to a predefined actuarially fair calculation agreed between the participants;
   wherein in operation some or all of the longevity risk is operable to be transferred to the group of participants and an income stream of payments to the participants is made available for as long as they live or until there is only a predetermined number of survivors remaining from the original group or where a predefined time has elapsed after formation of the group or after the occurrence of another predefined circumstance.

According to fourth aspect of the invention there is provided a non-transitory computer-readable medium having stored thereon instructions which, when executed by one or more computers or one or more computer servers, cause the one or more computers or one or more computer servers to perform operations to implement the distribution of an income stream of payments to a group of participant individuals for an indefinite period associated with the longevity of the participants, the operations to implement the distribution of an income stream of payments comprising:
an information collection operation relating to the information associated with a plurality of potential participants, the information including mortality criteria;
an identification operation, from the information collected, that identifies common mortality criteria and/or common expected mortality calculated from some or all of the mortality criteria relating to some or all of the potential participants indicating a substantially equivalent mortality risk;
a definition operation, that defines, from some or all the identified common mortality criteria and/or the common expected mortality, requirements for inclusion of potential participants in one or more substantially homogeneous mortality risk groups;
an identification operation, identifies a plurality of participants having a substantially equivalent mortality risk as determined by meeting the requirements for inclusion in the one or more groups;
a group formation operation, that forms one or more groups of some or all of the identified participants, the matching of the participant in any group being selected by the participant or on behalf of the participant;
an investment operation, that establishes a group investment fund, the investment fund being the aggregation of investment payments received from or on behalf of each participant in the group;
an investment operation, that invests some or all of the investment fund in an asset allocation portfolio in accordance with predetermined investment guidelines intended to grow the investment fund; and
a distribution operation, that distributes a portion of the investment fund as payments at predetermined distribution periods, the portion being made available for distribution payments at the completion of any period being calculated according to a predefined actuarially fair calculation agreed between the participants;
   wherein some or all of the longevity risk is transferred to the group of participants and an income stream of payments to the participants is made available for as long as they live or until there is only a predetermined number of survivors remaining from the original group or where a predefined time has elapsed after formation of the group or after the occurrence of another predefined circumstance.

### BRIEF DESCRIPTION OF THE DRAWINGS

FIG. 1 shows a mortality distribution;

FIG. 2 shows the evolution of retirement age and life expectancy, and extended retirement periods;

FIG. 3 shows, by way of example, graphic representations of the cash flows relating to three possible participants;

FIG. 4 shows the market positioning of the Survival Sharing offering in accordance with the present invention;

FIG. 5 shows the Survival Sharing process;

FIG. 6 is a flow chart of the processes undertaken in the contribution stage of the system of the invention;

FIG. 7 is a flow chart of the processes undertaken in the accumulation stage of the system of the invention;

FIG. 8 is a flow chart of the processes undertaken in the distribution stage of the system of the invention;

FIG. 9 provides a legend for the flowcharts represented in FIGS. 6, 7 and 8; and

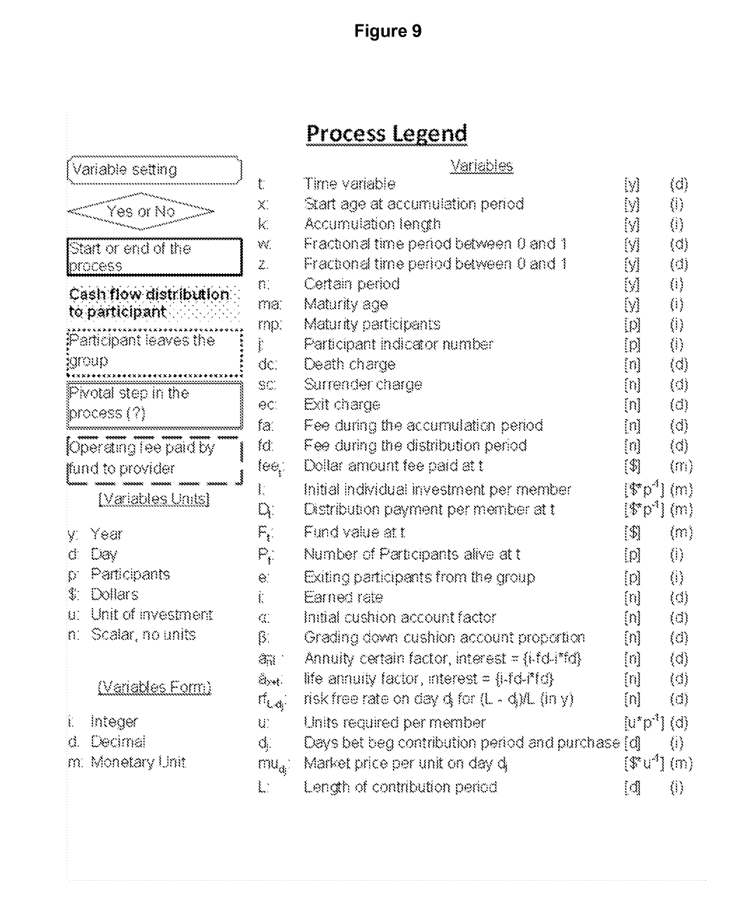

FIG. 10 contrasts the product cycles between traditional insurance products to a Survival Sharing product.

The illustrations are intended to provide a general understanding of the concepts described and the structure of various embodiments, and they are not intended to serve as a complete description of all the elements and features of methods and systems that might make use of the structures or concepts described herein. Many other embodiments will be apparent to those of skill in the art upon reviewing the description. Other embodiments may be utilized and derived therefrom, such that structural and logical substitutions and changes may be made without departing from the scope of this disclosure.

It should also be appreciated that the figures are merely representational, and are not be drawn to scale and certain proportions thereof may be exaggerated, while others may be minimized. Accordingly, the specification and drawings, together with any examples, are to be regarded in an illustrative rather than a restrictive sense and the specific form and arrangement of the features shown and described are not to be understood or interpreted as limiting on the invention.

### DESCRIPTION OF EMBODIMENTS

In most developed countries, retirement planning is a growing concern, both from an individual and a societal point of view. The use of defined benefit plans (DB plans) has decreased significantly over the last few decades. Governments of developed countries around the world struggle with pressing and more noticeable issues such as financial system stability, health care, alarming deficits and high unemployment. In the private sector, firms struggle with aging workforce, high volatility of pension contribution and accounting, high pension administration cost and underfunded plans; which are all reasons that triggered the decline of DB plans in favor of the use of defined contribution plans (DC plans).

Retirement issues are not tackled as an urgent matter, leaving individuals with the burden of planning and providing for their own long term financial needs. This increasingly growing reality has opened up a world of both new challenges and new opportunities. Many individuals are facing serious longevity risk, which is the risk of outliving one's assets. Many professional associations and organizations foresee longevity risk as a major concern in the current social, economic and demographic environment.

The need for individuals to manage longevity risk can be introduced by way of an illustrative hypothetical. As our population ages, how would a 65-year old widowed father of two, with $1,000,000 in assets, manage his retirement? If he dies tomorrow, he will leave half a million dollars to each of his children. If the same man dies in 35 years and is confined to a nursing home for the last 10 years of his life, his two children may have to support him financially for several years. In retirement planning, a lot of importance is placed on variables such as diversification, risk, liquidity, fees and service. Surprisingly, very little emphasis is placed on the most important variable of all: How long we are going to live?

If this individual has no lifetime income, he will rely on his capital and investment gains to provide for himself. Even assuming the individual diversifies his asset portfolio to the maximum extent possible, picks stocks in a better way than the very best professionals can and does it all solely by himself without incurring any fees; the individual still does not know when he will die. What is the optimal investment strategy in order to provide for funds for the rest of one's life, when one does not know what that life span will be?

Further, should the amount any individual wishes to leave their heirs rely so heavily on the unknown variable of longevity? By allocating a certain amount of savings to a life income product, one can exert a greater degree of control over the likely amount that may be left for inheritance. If our same individual has no life income, the difference between dying very early or very late can have a significant financial impact on his succession; as an early death will leave a substantial inheritance, while a late death may turn the parent into a liability for the children. If a certain part of savings could be converted to a life payment, the individual would depend less on his non-periodic portion of saving.

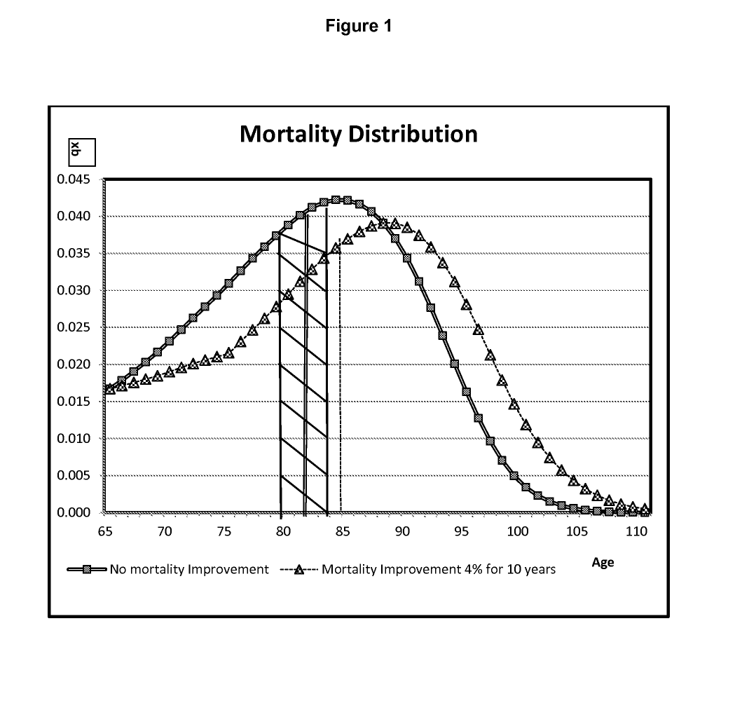

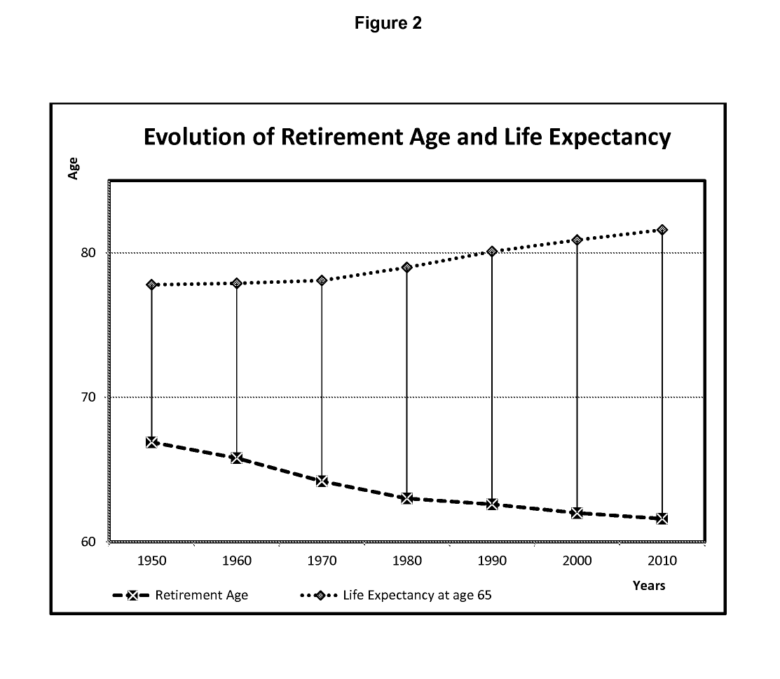

Individuals face a more serious longevity risk than their parents a generation ago; longevity risk is increasing and numerous factors appear to be shifting the risk to individuals, including the following:
Governments and corporations have altered their strategy relating to the assumption of large risks (longevity, economic, demographic or regulatory) and have shifted part of the burden back to individuals. In addition, alarming government debt levels coupled with advancements in technology (leading to longer life spans) have further emphasized the need for individual longevity protection.
Individuals can expect to attain or exceed projected life expectancies easily; but as the expression implies, life expectancy is an expected value, which is nothing more than the weighted average of a distribution. Individuals remain unable to predict where they will fit on that distribution, i.e., when they will die. FIG. 1 shows such a mortality distribution. According to the “2007 Period Life Table for the Social Security”, a 65 year old male is expected to live to age 82, as illustrated with the dashed vertical line of FIG. 1. However, an expected value is not a certain indication of when that individual will actually die. In fact, according to the same assumptions used to determine this life expectancy, that same man (at age 65) has approximately only a 4% chance of dying at age 82. Further, that same individual has a 20% chance of dying in his early 80s (80 to 84), as illustrated by the hatched area on FIG. 1. In other words, our 65 year old man has a 96% chance of not dying at his life expectancy age (82 years old) and an 80% chance of not dying in his early 80s.
The American Academy of Actuaries (AAA) points out that over 30% of females aged 65 will live beyond age 90 (see N. Abkemeier, N. Bennett, D. Fuerst, T. Manning and T. Terry, “Lifetime Income: Risks and Solutions,” 2012). Put differently, if all women at age 65 plan to live up to age 90, 3 out of 10 will be in serious financial trouble; at a time when they will very unlikely be capable of going back to work. Also, the other women who died earlier could have deployed more capital earlier in their retirement, hence increasing their spending confidence level if they had somehow annuitized part of their funds as opposed to using a constant withdrawal method (such as the 4% rule—see, for example, C. O'Flinn and F. Schirripa, “Revisiting Retirement Withdrawal Plans and their Historical Rates of Return,” O'Flinn Schirripa, 2010).
Further, life expectancy is likely to change over the course of a few decades, as illustrated with the solid vertical line of FIG. 1 (if there is a 4% mortality improvement for 10 years in comparison to the original assumptions). This adds another obstacle for individuals trying to predict when they will die.
With computer capabilities and technological advances reaching new levels every day, it is impossible to predict where technology will lead us. For example, in a US Time Magazine article about Gleevec (a drug manufactured by Novartis used to treat certain cancers), Dr. Larry Norton of Memorial Sloan-Kettering Cancer Center declared: “I think there is no question that the war on cancer is winnable” (see M. D. Lemonick, A. Park, D. Cray and C. Gorman, “New Hope for Cancer,” Time Magazine, 2001). Further, Bloomberg News reported in early 2012 that “The 30-year quest for an AIDS cure advanced as scientists succeeded for the first time in attacking HIV in its hardest-to-reach hideouts with a cancer drug made by Merck & Co” (see R. Langreth and S. Pettypiece, “AIDS Cure Quest Advances as Cancer Drug Finds Hidden HIV,” Bloomberg, 2012). These examples suggest a major medical breakthrough, such as a cure for a major disease or a successful preventive approach for a condition suffered by many, is possible in the medium term; resulting in a significant increase of life expectancy.
Retirement time span has increased in the last few decades; individuals not only live longer, but also retire earlier, according to an Allianz working paper (see S. Benartzi, A. Previtero and R. H. Thaler, “Annuitization Puzzles,” Allianz, 2011). FIG. 2 is taken from the same paper and illustrates very well this statement showing the evolution of retirement age and life expectancy. With people being retired for a longer period of time, it is clear that longevity risk is becoming increasingly more important.
The surrounding economic, social and demographic environment coupled with governmental situations fuel speculation on future inflation paths in the decades to come. Central banks may succeed in fulfilling their usual key objective of maintaining inflation rates at a reasonable level, but other factors may overcome these efforts and push inflation higher than is economically desirable and conducive to growth.
Public debt in many countries has grown at an alarming rate and is now a global issue. Many fear that public sector undertakings made may not be supportable and that benefits like future pensions promised by governments may be compromised.

Three major insurance vehicles are currently available for addressing longevity risk: governmental benefits, defined benefit pension plans and guaranteed lifetime income products. Current trends suggest that defined benefit plans (DB plans) are being replaced with defined contribution plans (DC plans). According to Towers Watson, in 1998, 90 of the Fortune 100 companies offered a DB plan. By 2010, that number had decreased to 42. Given these trends, it would perhaps be natural to expect a rise in demand for private lifetime income instruments. However, a recent Society of Actuaries paper suggests this is not the case: “Economic literature has nearly unanimously agreed that, at least from a pre-tax personal income perspective, the financial welfare of most retirees would be enhanced by annuitizing a substantial portion of their wealth. The lack of demand in the private annuity market has given rise to a large body of research that attempts to understand the aversion of individuals to annuitize.” See B. J. MacDonald, B. Jones, R. Morrison, R. Brown and M. Hardy, “Research and Reality—A Literature Review on Drawing Down Retirement Savings.,” Society of Actuaries, 2011). This aversion would effectively leave only governmental plans protecting individuals from longevity risk; a social mechanism where individuals have limited control. There are a number of shortcomings with each of the three alternatives, namely:
Governmental Plans
   Many individuals rely on a governmental plan (such as Social Security in the US) as their main or supplemental source of lifetime income. However, there is considerable uncertainty regarding the future of these programs. In the US, the following sentence appears on individual social security statements: “Without changes, in 2033 the Social Security Trust Fund will be able to pay only about 75 cents for each dollar of scheduled benefits. We need to resolve these issues soon to make sure Social Security continues to provide a foundation of protection for future generations.” In order to fund this liability, the government will have to take intervening actions (fiscal or others) which pose a threat to the benefits that will be available future retirees. An additional weakness of governmental plans is the limited control afforded to individuals over their retirement planning and benefits, as the government unilaterally determines the benefits to which they are entitled. Furthermore, many individuals may need a way to manage any additional personal savings through retirement.
Defined Benefit Plans
   Many factors explain the shift from DB to DC plans. The common explanation that DB plans are simply too expensive is not entirely consistent with the nuances of the situation. First, it is hard to compare the expenses of DB and DC plans on an apples-to-apples basis as the two structures are completely different. Second, it is unlikely that even the perception of expense would adequately explain the ubiquitous shift; pension benefits are part of compensation packages which are dictated by the laws of supply and demand. Both employers and employees have issues with DB plans and the ongoing migration from DB to DC plans is likely due to multiple factors including:
   From an employer's perspective:
      Volatility of contributions and accounting measurements creates uncertainty. Mortality and economic figures change greatly over time and can impact significantly the financial situations of both employees and employers, favorably or adversely. A promised benefit payment that seems adequate for an individual at a given time may be insufficient or larger than necessary for the same individual a decade later, resulting in potential undesirable large profit swings.
      Administration costs have increased. The new age of employee mobility may have hastened the demise of pension plans. With a larger number of employees both joining and leaving a company every year, the cost of administering a pension plan have become far more expensive and laborious than it was when employee turnover was much smaller. Further, the increase in regulatory constraints has also contributed to the increase in administration costs in the past few decades.
      Plans are underfunded. When pension plans are underfunded, the plan sponsor has to close the gap on the shortfall through a mix of contributions or excess returns. Increasing risk by having more growth assets introduces considerable financial volatility for the sponsor which is not generally desirable. On the other hand, making significant contributions may not be appealing in an economic downturn. As a result, many sponsors have decided either to close the plan to new hires or even freeze the plan to existing participants. This can have an effect on different generations of workers. It can also lead to multiple cost attributions problems, personnel issues, work conflicts and even, in some cases, bankruptcy.
      Time horizon difference. Management's compensation and incentives time horizons are usually much shorter than pension guarantees' time horizons. This may put popularity, compensation and long term solvency into a conflicting triangle.
   From an employee's perspective:
      Lack of interest. Money down the road has limited value to people in general, especially when it is associated with having to stay employed with the same employer. Employees may be more likely to appreciate the value of an immediate salary raise than a pension augmentation, even if the value of the compensation for the latter is higher.
      Portability. A few decades ago, it was not unusual to see employees work for one company for their entire career. As employment mobility has increased, a more portable pension benefit system has become desirable, if not necessary.
      Inflation risk. As noted above, inflation risk is a serious consideration from the perspective of a newly retired worker starting to receive benefits. Very few DB plans are inflation adjusted in the US and while non-inflation adjusted DB plans guarantee a certain payment at a point in time, they do not necessarily guarantee that the value of the payment will meet the future costs of living.
      Heterogeneous society. The typical DB plan was designed using the assumptions of a past generation and did not envision the myriad of ways in which the nuclear family has changed. It is normal that the needs for retirement change and adapt to meet different lifestyles and situations. Many segments of society are opting for plans which can accommodate the portability and flexibility that suits their individual situation.

Some solutions do currently exist in society to mitigate the risk of becoming a financial liability to dependents or the state. For example, various type of income annuities (variable and fixed) and other life guaranteed products are available in the market place and presented as potential solutions against longevity risk, but their sales have not yet reached close to the level needed to offset the decrease in DB pension plans. This may be explained by the following factors:
Expensive: insurance companies are in the business of managing risks. Those risks come at a cost. As noted by MacDonald et al: “Annuities are overpriced from an actuarial perspective in that the actuarial present value of the premiums is greater than the actuarial present value of the benefits (Mitchell et al., 1999; Orszag, 2000). This is owing to the insurer's administrative costs that are built into the premiums to cover marketing costs, corporate overhead, income taxes, regulatory compliance, contingency reserves, and profits, as well as the expensive mortality assumptions arising from adverse selection.” Drivers affecting cost include:
   Reserves and capital. Annuities, just like all other insurance products, are largely regulated. Reserve and capital requirements imposed by regulators are usually very conservative in order to protect the general public. An insurance company must hold funds aside to ensure its ability to honor commitments under various contingencies (i.e. interest rate changes, mortality shifts, etc.). These assets usually return a lower rate than what investors in insurance companies require. So in order to maintain the return required by investors, insurance companies must embed the cost of reserving into policyholder premiums.
   Reinsurance and securitization. Reinsurance and securitization transactions are often logical strategies for insurance companies to pursue. However, a transaction of this type of comes at a cost, which is ultimately transferred to the policyholder.
   Selling expenses. The nature and complexity of annuities often require the involvement of an intermediary (a broker or an agent) which can add up to the ultimate cost needed to offer the product, which is assumed by the policyholder.
   Profits. Shareholders of insurance companies demand a high return on their investment (annuity profit targets are usually in the 10-12% range (see N. M. Kenneally and C. J. Bierschbach, “Measuring Profitability,” 2010; and M. R. Katcher and N. M. Kenneally, “Measuring and Improving Profitability,” in Session 57 PD, 2011) since they are assuming a significant risk. Ultimately, this load is passed on to the policyholder.
Anti-selection. The process for underwriting income annuities is often less strict than that for life protection products. While the longevity risk facing individuals in good health may be obvious, the longevity risk facing individuals in poor health cannot be ignored. This is important because the current products are an unattractive solution for the latter group since they are priced using assumptions for the entire pool with no differentiation. Impaired annuities have not yet reached a strong market, especially in North America where less than 12 carriers offered impaired annuities in 2005. This, in turn, triggers a vicious cycle where income annuities remain immovably priced for a healthy population, since only healthy individuals are motivated to buy the product under its current pricing structure.
Lack of transparency. The concept of an annuity is not easily grasped by a layperson and the terms of guarantees and fees are not always transparent. Variable annuities can be especially complex, as pointed out by Hube in Barron's: “Given a dizzying number of features and restrictions, contracts for some annuities—variable and otherwise—can run 300 pages or more. And because each comes with its own small twists, these products can be very difficult to compare.” (see K. Hube, “Top 50 Annuities,” Barron's, 2012).
Mortality concerns. Compared to a traditional life insurance product, where customers usually assume the small payment of a premium in exchange for a large benefit, the early death of a policyholder can result in a significant financial loss in the case of a life guaranteed product. There is a risk that an individual may not benefit from his/her lifetime savings in case of early death just after annuitization.
Marketing challenges. While individuals are happy to benefit from employer-funded pensions, they may be less likely to purchase an income annuity of equivalent value, as it usually requires a significant financial commitment upfront.

The present invention relates to the concept of “Survival Sharing”, whereby small or large groups of individuals with similar mortality characteristics pool their investments together and receive distribution payments from that pool according to a set of predetermined and actuarially fair criteria. Survival Sharing shifts the investment and the mortality risk to the group of participating investors in a way that hedges each individual against longevity risk.

In recent years, a few academic papers have touched on how variations of the tontine concept could be adopted in modern times. One variation, described by Wadsworth et al. in “Reinventing Annuities,” Staple Inn Actuarial Society, 2001, is the annuitized fund. In his 2005 paper, Piggott builds a solid foundation for “group self-annuitization” and presents a robust mathematical model (see J. Piggott, E. A. Valdez and B. Detzel, “The Simple Analytics of a Pooled Annuity Fund,” 2005). Stamos builds on this model by discussing the optimization of consumption and asset allocation in the context of pooled annuity funds (see M. Stamos, “Optimal Consumption and Portfolio Choice for Pooled Annuity Funds,” 2007). Piggott's model was further refined by Qiao et al., who proposed adding a systematic mortality risk component (see C. Qiao and M. Sherris, “Managing Systematic Mortality Risk with Group Self Pooling and Annuitisation Schemes,” Australian School of Business Research Paper No. 2011ACTL06, 2011). In Goldsticker's 2007 paper, he introduces a practical tontine variation where shares of deceased members are separated among survivors (see R. Goldsticker, “A mutual fund to yield Annuity-like Benefits,” Financial Analyst Journal, a CFA publication, Volume 63, 2007). Baker et al. proposes the tontine concept in a non-longevity context: health coverage for young adults (see T. Baker and P. Siegelman, “Tontines for the Young Invincibles,” REGULATION, WINTER 2009-2010). In his 2009 working paper, Rotemberg proposes a variation of tontines called a Mutual Inheritance Fund (MIF) where shares of deceased members are separated among surviving members, enabling an increasing payoff between survivors through time (see J. J. Rotemberg, “Can a Continuously—Liquidating Tontine (or Mutual Inheritance Fund) Succeed where Immediate Annuities Have Floundered?,” Working Paper, 2009). His model differs from Goldsticker's by proposing increasing distributions, as opposed to annuity-like benefits. Sabin introduces yet another variation called the Fair Tontine Annuity (FTA), where he presents, among other things, a sophisticated algorithm to allocate deceased tontine members' shares back to surviving members (see M. J. Sabin, “Fair Tontine Annuity,” 2010). These ideas share some similarities with each other and with the present invention, while the present invention simultaneously maintains several elements of distinctiveness.

The present invention consists of forming homogeneous groups of a sizable number of individuals possessing similar characteristics (such as the same age, gender, health condition, etc.); which characteristics relate to mortality criteria and/or enable determination of expected mortality from the mortality criteria. Each group participant then contributes the same amount to an investment fund. Similar to a traditional annuity, the present invention generally includes two phases: the accumulation phase and the distribution phase. The investment fund typically includes an asset allocation portfolio, which is invested and reinvested with a view to the generation of investment returns in the accumulation phase, in a manner analogous to a mutual fund. At a predetermined date, after an accumulation period of the accumulation phase, the investment fund is redistributed in an actuarially fair way to each surviving participant investor in small installments over time, mimicking an income annuity payment benefit. Typically, at each period, the actuarial evaluation is conducted according to the mortality experience of the group, the fund performance and the new surrounding environment (in respect of investment prospects and expected mortality of the group). Distribution payments are recalibrated and distributed among the survivors of the group.

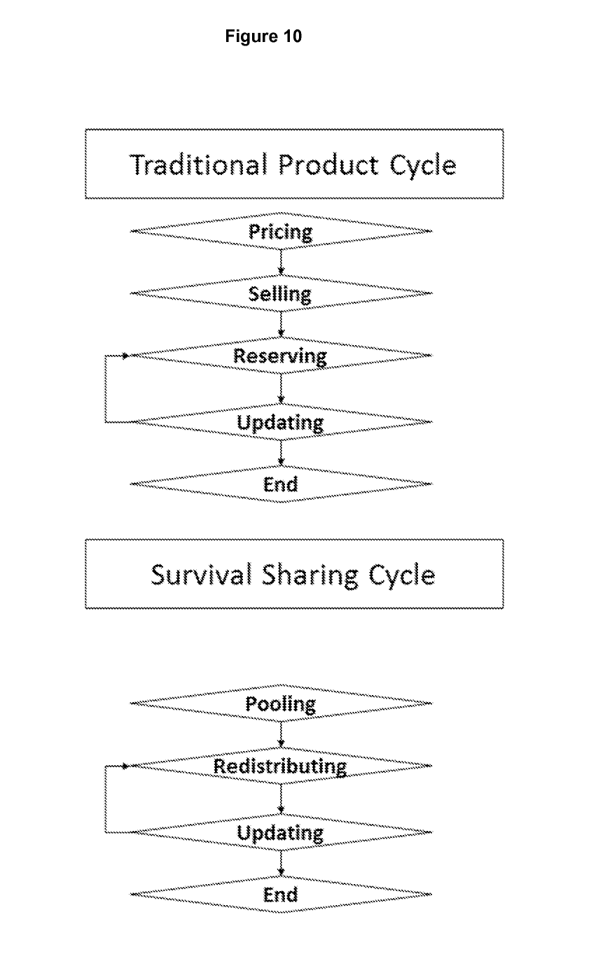

As shown in FIG. 10, the Survival Sharing cycle differs from that of a traditional insurance product in that the latter is usually priced and sold before entering an iterative process where claims are paid and reserves established. In contrast, Survival Sharing pools investments of individuals before entering its iterative process of redistributing the fund in an actuarially-fair manner.

Among other roles, the provider acts as an independent redistributor of the fund. A provider is typically an institution possessing the appropriate rights and expertise to provide the Survival Sharing product to consumers. The goal of the provider is to keep payments close to the desired pattern predetermined in each group, while simultaneously protecting survivors against ruin.

Each member is expected to receive a life annuity payment, but since the group of investors is assuming the mortality and investment risk, the distribution will vary over time.

Group size is relevant (a high number of participants decreases the sample risk for each individual), but substantial group mortality homogeneity is of even greater importance in maintaining the overall fairness of concept. Individuals have the availability to reduce sample risk by purchasing multiple shares of groups formed and operated in accordance with the present invention on their own timeline.

Example: One year (see section “calculation details” for assumptions)
In a first example, 10 male participants each contribute $10,000 at age 45 (at t=0) and agree to receive distributions from the fund at age 65 (at t=20). No deaths or surrenders occur during the accumulation phase and the net annual return is 4.6880235%. After 20 years, the initial fund of $100,000 has grown to $250,000 and the initial annual distribution per member at age 65 is $2,148. The distribution amounts will be recalculated periodically, taking into account variations in mortality experience and expectations, investment returns and economic environment. Assuming the rate of return and assumed interest rates remain unchanged in the following year, the fund will now have a value of $239,237 at age 66 (at t=21). Scenario #1 assumes no participant will die during this year. The resulting balance is split among the ten individuals, which results in a distribution payment of $2,114 per member at age 66 (at t=21). Scenario #2 assumes the same investment returns, but this time one participant has died during the year; the balance is split among the nine remaining individuals, which results in a distribution payment of $2,349 per member at the age of 66 (at t=21). The member who passed away exits the group and will no longer receive distributions. The following table summarizes the payments after one distribution year.

| Time | Age | Feature | Scenario #1 | Scenario #2 |
|---|---|---|---|---|
| t = 0 | age = 45 | Fund Value₀ | $100,000 | $100,000 |
| t = 20 | age = 65 | Fund Value₂₀ | $250,000 | $250,000 |
| | | Participants₂₀ | 10 | 10 |
| | | Distribution₂₀ | $2,148 | $2,148 |
| t = 21 | age = 66 | Fund Value₂₁ | $239,237 | $239,237 |
| | | Participants₂₁ | 10 | 9 |
| | | Distribution₂₁ | $2,114 | $2,349 |

This process transfers the investment and the mortality risks to the entire group. This example is used for illustrative purposes; in a real situation, mortality would be reevaluated, interest rates would be reassessed, a fee for service might be deducted from the account value and multiple other provisions can be made available to investors at a fee.

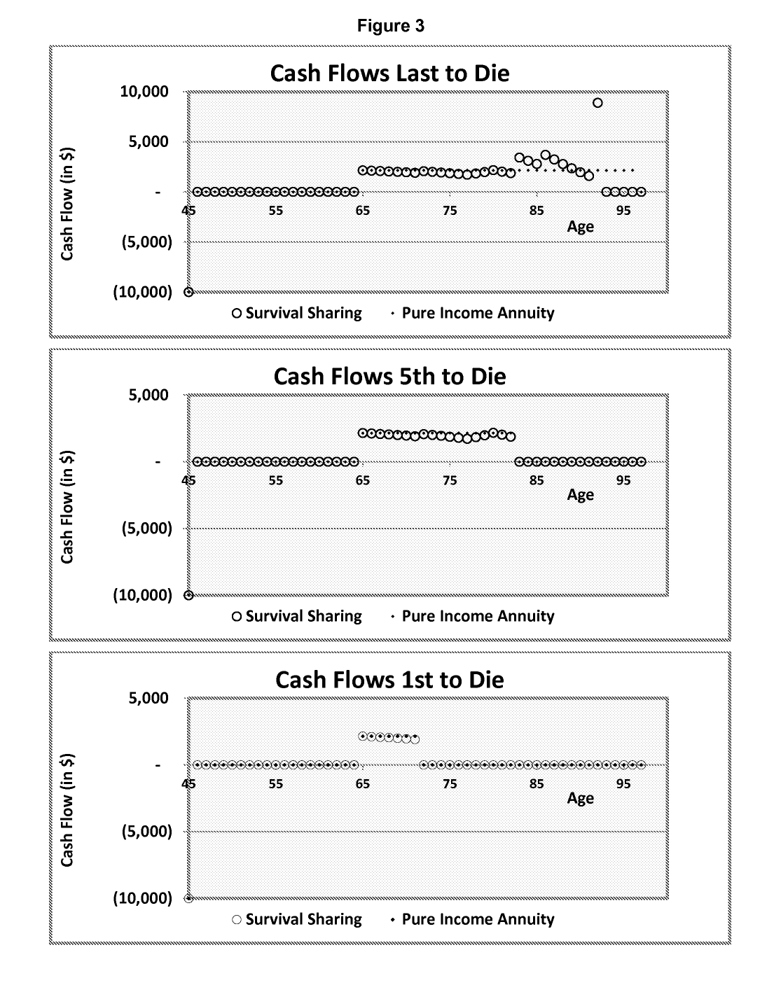

Example: Three Participants
This example looks at the cash flows (for the same original group in the example above) of three different participants throughout the life of the pool. For purposes of this example, the three individuals selected are: the first, fifth and last to die within the group. Cash flows are compared to an income annuity, deferred for 20 years and then annuitized. In order to illustrate the mechanism, for both sets of cash flows, expenses are ignored, the same assumptions are applied for mortality and investment returns and those assumptions remain fixed throughout the projection. Payments distributed as cash flows in accordance with the present invention are populated using a simulation process, while cash flows for the annuity are calculated using simple deterministic assumptions. Cash flows are illustrated in FIG. 3.
In the case of the first death (at age 71) the annuity and present invention have very similar payouts. In the case of the fifth death (at age 82) the cash flows are again very similar, with a slight increase in volatility for the present invention. For the last to die (at age 96) the present invention cash flows are more volatile than the income annuity benefit payments. The high cash flow at age 92 corresponds to the remaining account value in the fund after the second to last participant dies. The amount is expected to be enough for the last survivor to buy an income annuity and get a similar life payout. In practice, this individual could buy a similar mortality group under the present invention and obtain a comparable distribution payout.

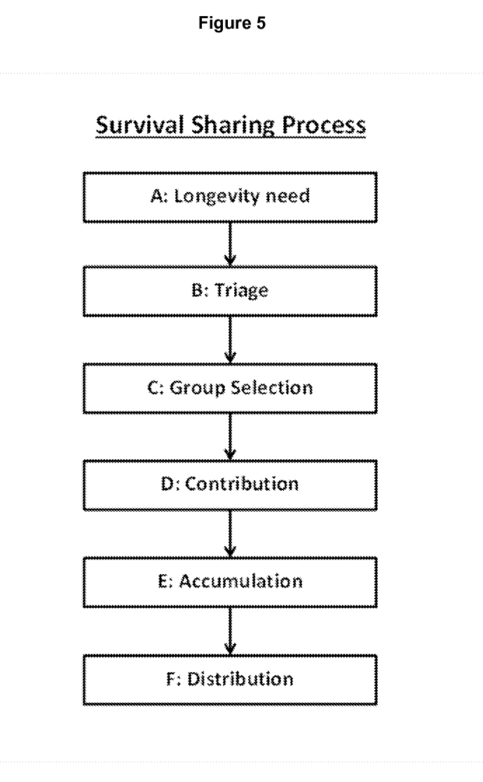

FIG. 5 shows the steps that may be undertaken in the practicing of the present invention. In step A an individual realizes the need for longevity and typically establishes contact with a Survival Sharing provider (although in theory individuals could undertake the steps independent of a provider). It will be appreciated that the provider may undertake certain marketing activity to promote Survival Sharing. In step B, a triage phase leading to group establishment, the individual inputs his/her objective personal characteristics (into an information receiving module), including certain mortality criteria (information that may be used in assessing the individual's personal expected mortality), including the date of birth (age), gender, medical history and independent diagnosis (made by professional third party and/or by an electronic system algorithm). Additional information such as job type, participation in sports and activities, personal habits (smoking, drug use etc.), may be considered mortality criteria. The provider gathers the data collected and results generated from information collected (such as expected mortality determined in whole or in part from mortality criteria) and stores this all in a readily available database.

In step C, group selection, the individual chooses a group from the available option features and the provider allocates the individual into a group. Given the data provided in step B, a software program is typically used (in the information receiving module) to identify common mortality criteria and/or common expected mortality of potentially participating individuals who have provided information. From this, in a mortality assessment module, requirements for inclusion in one or more groups (assessed as having substantially comparable homogenous mortality risks) are defined. Using a group formation module, groups that may be available to the individual (meeting the requirements) are then identified and displayed to the individual for selection, or the provider allocates an individual to a selected group without reference to the individual. Generally, the provider software generates standard options with standard features from the available groups, or conversely, the individual can input his/her preferred features and the software can suggest a close matches according to those preferences.

A group is then formed with a plurality of appropriately categorized individuals.

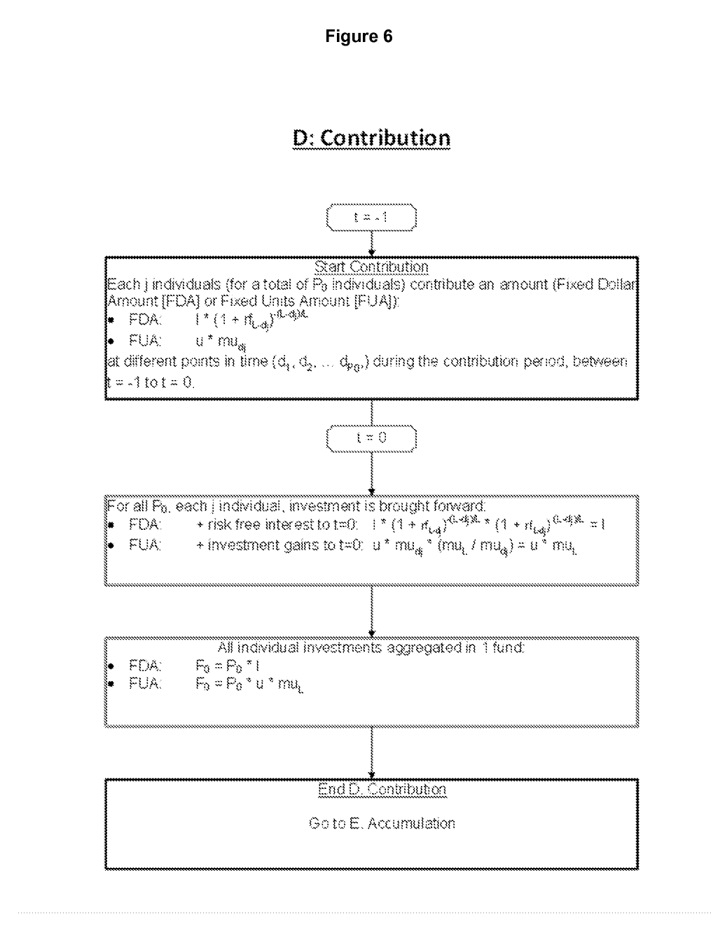

In step D, contribution, each participating individual makes a payment into an investment fund formed in an investment module (typically investing some or all of the proceeds into an asset allocation portfolio for investment in accordance with agreed guidelines intended to grow the investment fund). FIG. 6 shows the contribution considerations.

Assumptions:
Let dⱼ be the number of days between the beginning of the contribution period to the moment participant j makes its purchase.
   For example:
      The beginning of the contribution period is January 1 of the prior year.
      Participant #7 makes its contribution on March 2: d₇=61
   Each member makes their contribution on different day dⱼ (each dⱼ representing the contribution day of member j)
Let L is the length of the contribution period, hence the number of days in a specified contributing period.
   For example, if the contribution period is a year: L=365
0<dⱼ=<L j=1, 2, . . . , P₀
There are 2 possible contribution arrangements:
   Fixed Dollar Amount (FDA)
      The contribution is structured such that the dollar amount at the end of the contribution period each participant contributes to is equal.
      The contribution amount required for each participant is solved for, according to the time of contribution and the available interest risk free rate for a period of L-dⱼ.
      Let rf_{L-dj} be the risk free annual interest rate on day d for a period of (L−dⱼ)/L (in years).
      Let I be the dollar amount Initial Individual Investment.
         For example, I could be $10,000.
      On day dⱼ, Individual j contributes a dollar amount of: I*(1+rf_{L-dj})^{-(L-dj)/L}
      On day L (moment of inception), Individual share is worth: I
   Fixed Unit Amount (FUA)
      The contribution is structured such that the unit amount at the end of the contribution period each participant contributes to is equal.
      The contribution amount required for each participant the market value of those units on dⱼ.
      Let u be the unit amount required for participation in a pod.
      d Let mu_{dj} be the market price of a unit on day dⱼ.
      On day dⱼ, Individual j contributes a dollar amount of: u*mu_{dj}
      On day L (moment of inception), Individual share is worth: u*mu_{L}

The establishment phase is now complete.

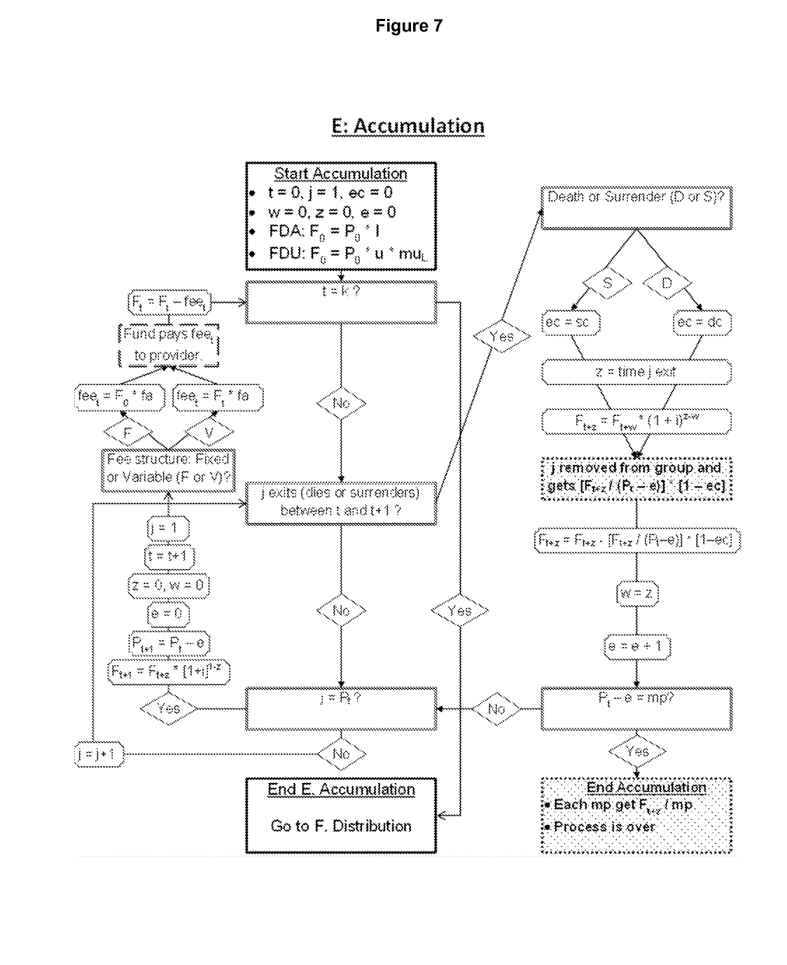

The investment module is utilized for an accumulation period determined in advance (group formation). In this accumulation phase, step E shown in FIG. 7, the following assessment may apply:
Pₜ is the number of participants still in the pool at t.
j=1, 2, . . . , Pₜ represents each participants in the pool, ranked in activity occurrence (death or surrender) from the earliest to the latest.
z and w are the fractional period between t and t+1 at which the event occurs. z is the elapsed time from the beginning of the period to the event occurrence. w is the elapsed time from the beginning of the period to the prior event occurrence if such event occurred. (0 otherwise). For example, member 1 surrenders on Jan. 25, 2019, member 2 dies on Jun. 12, 2019: w=0, set z=25/365, set w=25/365, set z=163/365.
e is the number of members exiting the pool between t and t+z.
i is the interest rate used to forward account balances. The current flow charts indicate a constant rate through time for simplicity and illustrative purposes, but it should be noted that interest rates will vary through time and maturity.
fa is the fee (% of fund value) used to calculate the fee charged to the Survival Sharing provider during the accumulation period. The current flow charts indicate a constant rate through time for simplicity and illustrative purposes, but it should be noted that this fee may vary through time. The same applies for fd in the distribution step, step F. It can also be a % of the initial fund value, resulting in a constant dollar fee amount each year.
fd is the same as fa, but the fee applies during the distribution phase. fa and fd may or may not be equal.
ec is the Exit Charge, which is a temporary variable that takes either sc or dc as value. sc and dc are Surrender Charge and Death Charge respectively (% of fund value). Charge paid by the member to the remaining of the group upon exit of the group.
If Individual dies at t+z:
   Receives DV_{t+z}=[F_{t+z}/(Pₜ−e)]*[1−dc]
   DV_{t+z} is removed from fund.
If Individual surrenders at t+z:
   Receives SV_{t+z}=[F_{t+z}/(Pₜ−e)]*[1−sc]
   SV_{t+z} is removed from fund.
In the unlikely event that all but the pre-specified number of forced maturity participants die during the accumulation phase, the remaining fund value is distributed to the last surviving members.
On January 1^{st}, (the day could vary in order not to overflow markets one specific day of the year) a fund F₀ is created (FDA: F₀=P₀*I or FUA: F₀=P₀*u*mu_{L}) so all participants are equi-owners of the fund, regardless of the day (in step D) they contributed to the fund.

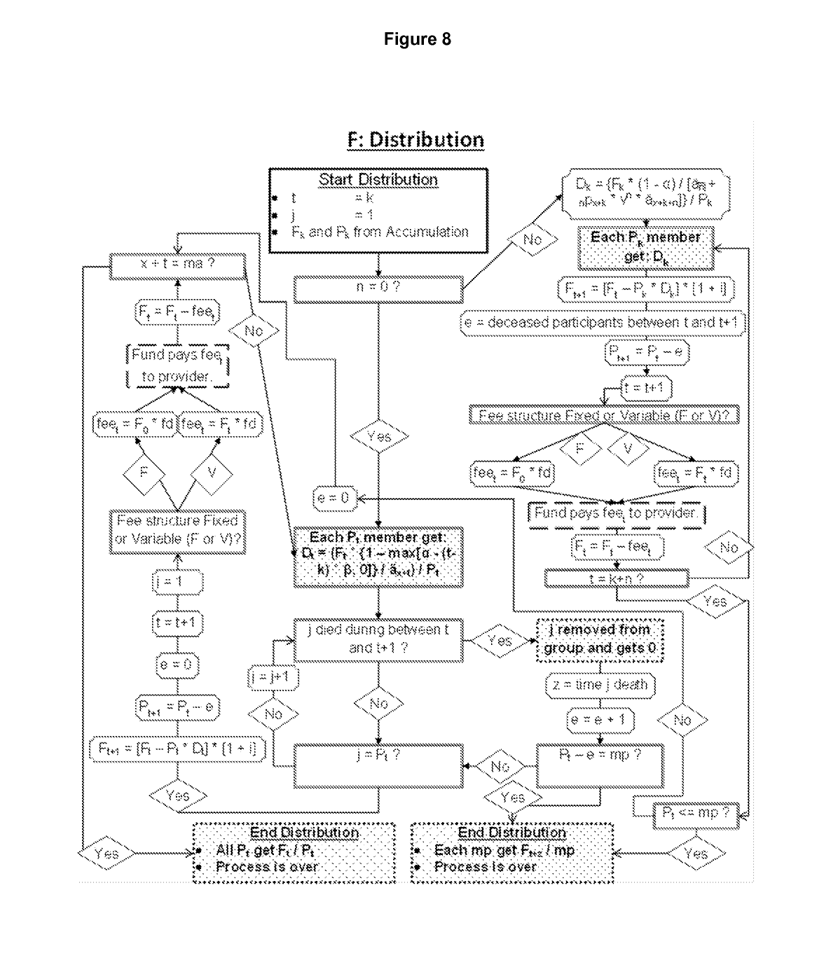

FIG. 8 shows step F, Distribution, which applies at the end of the accumulation period. The Individual has no surrender value. Using a distribution module to distribute payments from the investment fund, the individuals receives:
Receives Dₜ periodically until death or end of certain period, whichever comes last.
Receives 0 afterwards.
Last mp surviving members receives F_{q}/mp, q being the moment that a member from the remaining mp+1 survivors dies. If Pₜ₊ₙ<=mp (the number of participants is less than the maturity participants after the end of the certain period) Fₜ₊ₙ is distributed among the last mp surviving members (or their beneficiaries).
The provider periodically assesses the need of how much distribution from each member should receive from the fund. In the equation

$${D}_{t} = \frac{{F}_{t} * [ 1 - max ( α - ( t - k ) * β , 0 ) ] \text{/} {P}_{t}}{{\ddot{a}}_{x + t}} ,$$

the annuity factor äₓ₊ₜ needs to be evaluated according to future net (of provider fee) investment returns and future mortality expectation.
   Interest rate used for annuity factor: r=i−fd−i*fd.
   If the cushion account features is elected, it may be specified in the contract among a group that the provider may use judgment to deplete more rapidly the cushion account if unexpected situations occur. Such events can be (but not limited to):
      Economic event such as a drop in equity markets or unfavorable sudden change in interest rates.
      A sudden improvement in science such as a vaccine or a cure for a major disease that could impact future mortality.
Assessment
   Future mortality for each group may be determined using available tools and information at time of assessment such as (but not limited to):
      SOA, AAA or other professional association published mortality tables.
      Modifications of such tables such as (but not limited to):
         Flat percentage of a table.
         Mortality improvement.
      Actuarial Standard of Practice (ASOP) and other professional guidance.
      Various techniques such as (but not limited to):
         Predictive modeling techniques.
         Stochastic mortality analysis.
      Use conservative estimates.
   Future investment returns for each portfolio may be done using available tools and information at time of assessment such as (but not limited to):
      Tools such as (but not limited to):
         Interest rate scenario generator.
         Market consistent scenario analysis.
         Stochastic returns analysis.
      Actuarial Standard of Practice (ASOP) and other professional guidance.
      Type of funds
      Composition of existing portfolio.
      Separation of capital and investment income.
      Use conservative estimates.

Survival Sharing investment/distribution offerings of the present invention are characterized by a wide variety of flexible features including:
Investment assets. Investors among a pool need to agree on a predetermined asset allocation portfolio. The risk/reward preferences are determined by the individual.
Distribution age. While the current age may be fixed, the age at which distributions commence is left for the individual to decide (and agreed at formation with other participants).
Surrender charges. A surrender charge is a penalty (percentage of individual share of account value) the investor pays upon voluntarily withdrawal from the group during the accumulation phase (during the distribution phase, no withdrawals are available; if they were, anyone in the group facing a serious disease could pull out their money, thereby defeating the purpose of the product). For example, a 20% surrender charge would mean the investor only receives 80% of his/her share upon surrender. At first glance, this makes the investment less attractive as the investor incurs a penalty upon withdrawal, but the gain from it translates into the added security to the remaining of the group as this discourages investors from leaving the group pod. Further, the surrender of one member would be a gain to the remaining investors, as the penalty paid stays within the fund.
Death charges. A death charge is a penalty (percentage of share of account value) the investor pays upon death during the accumulation phase. For example, a 5% death charge would mean the investor only receives 95% of his/her share upon death. At first glance, this makes the investment less attractive as the investor incurs a penalty upon death, but the gain from it translates into the added security of providing funds for the survivors of the group pod. Further, a death charge would be a gain to the surviving investors as the penalty paid stays within the fund. A death charge is different from a surrender charge, as death (other than the obvious case of suicide) is not a choice. In the case of death, it is usually well accepted that the funds return to the investor with no penalty. However, some investors may opt for a higher death charge in exchange for a potentially larger benefit payout, and form the group upon this understanding.
Certain period payment. A certain period allows each investor to receive distribution payments, regardless of survival status, for a predetermined length. This lowers future recurrent distributions, as the fund is separated among all investors during the certain period. The benefit, from the individual's perspective, is that it decreases the risk of incurring a significant financial loss (for beneficiaries) in case of early death. The certain period may be defined as the achievement of a predetermined group age, or the elapsed time from formation. It is possible, and may well be considered preferable for efficiency reasons, to allow for the possibility of a settlement to the beneficiary of a deceased member to get the present value of the remaining certain payments at fair assumptions. This allows the beneficiaries to get funds upfront and allows the group to track one less individual.
Assumption level of conservatism. Periodic distributions from the fund are established using group mortality experience, investment returns and future expectations. At each time of distribution evaluation, mortality experience and investment returns are known, while future investment returns and mortality are unknown. In order to calculate the periodic distributions from the fund, the provider will need to make assumptions on the future mortality of the group and how much the fund will earn in future years. Here is a theoretical example that illustrates the interaction of both assumptions:
   The actual mortality matches the expected mortality.
   The actual investment rate of returns matches expected investment rate of returns.
      Mortality
         If expected mortality was assumed, actual distribution payments would be exactly level over time.
         If lower than expected mortality was assumed, actual distribution payments would start low and increase over time.
         If higher than expected mortality was assumed, actual distribution payments would start high and decrease over time.
      Investment returns (Investment returns are net of any fees charged by the provider)
         If expected investment returns were assumed, actual distribution payments would be exactly level over time.
         If lower than expected investment returns were assumed, actual distribution payments would start low and increase over time.
         If higher than expected investment returns were assumed, actual distribution payments would start high and decrease over time.
      Note on future mortality
         Each year, an expectation of future mortality needs to be reassessed, including mortality improvement. Simple mortality conservatism can be applied, or a more sophisticated approach such as Qiao and Sherris' proposal can be used. No matter how mortality systematic risk is modeled, it is a risk that is bared by the group and needs to be addressed. For example, the discovery of a cure to a major type of cancer could significantly impact future mortality expectations. Therefore, it is believed that a certain level of conservatism is prudent.
         Since longevity risk is the primary purpose of this vehicle, it is believe that it is reasonable to assume lower than expected mortality and investment returns.
Cushion Account
   A cushion account is a side fund from which payments are not withdrawn and is designed to lower the risk of decreased future distribution payments. The payment account is calculated as the difference between fund value and the cushion fund value. The cushion account can take 2 different forms:
      The cushion account starts at a certain level, a, and grades down to 0 over time at the rate of β per period.
      Initial cushion account factor: α (0≦α<1)
         At the start of the distribution (t=k), the account value is split in 2 accounts:
         Cushion Account: Fcₖ=Fₖ*α
         Payment Account: Fpₖ=Fₖ*(1−α)=Fₖ−Fcₖ
         The distribution payment is calculated:

$${D}_{k} = \frac{{Fp}_{k} \text{/} {P}_{k}}{{\ddot{a}}_{x + k}}$$

Grading down cushion account proportion: β (0<β≦α)
   In each subsequent year (t>k), α is decreased by β, grading to 0.
   Cushion Account: Fcₜ=Fₜ*max[α−(t−k)*β, 0]
   t=k, k+1, k+2, . . .
   Payment Account: Fpₖ=Fₜ−Fcₖ
   The distribution payment is calculated:

$${D}_{k} = \frac{{Fp}_{t} \text{/} {P}_{t}}{{\ddot{a}}_{x + t}}$$

The higher α is:
   The lower the original distribution payment will be.
   The less likely distributions will be below the initial distribution.
The lower β is:
   The more likely distribution payments will increase over time.
   The less likely distributions will be below the initial distribution.
At each point in time, the provider (under prior election of this feature) has discretion to redistribute the cushion account given unexpected situations. Such events can be (but not limited to):
   Economic event such as a drop in equity markets or unfavorable sudden change in interest rates.
   A sudden improvement in science such as a vaccine or a cure for a major disease that could impact future mortality.
Forced Maturity
   It is possible to terminate the process prior to the end of the natural ending (when the second to last member dies) and distribute the remaining funds evenly among survivors at a predetermined time.
   The maturity feature may be enabled by one of two criteria:
      The group pod has reached a predetermined maturity age (e.g. group age is 95 years old). Here it is important to clarify that the specific age relates to the representative age of the group as opposed to each individual age of the members in the group. In practice, each member within a pod will not have their birthday on the same day, but the early distribution will happen on one particular day, regardless of the age of each member. For example, if the maturity age is 95, the fund will be split on a particular date (e.g. January 1 when the group is “95 years old” or in “their 96th year”) among all surviving members, regardless of when each member actually turns 95.
      The number of surviving participants has dropped to a predetermined fixed lower bound (e.g.: pod number of survivors is four).

In summary, the following ranges of group activities may apply:

Individual Cash Flows

| Steps | State | Alive | Dead |
|---|---|---|---|
| A: Longevity Need | | 0 | N/A |
| B: Triage | | 0 | N/A |
| C: Group Selection | | 0 | N/A |
| D: Contribution* | Fixed Dollar Amount | | N/A |
| | | −I * (1 + rf_{L-dj})^{-(L-dj)/L} | |
| | Fixed Unit Amount | −u * mu_{dj} | |
| E: Accumulation | no action | 0 | |
| | on surrender* | SVₜ | |
| | on death* | DVₜ | |
| F: Distributionin | certain period** | Dₜ | Dₜ |
| | past certain period** | Dₜ | 0 |

*One-time payment
**Recurrent payment

| | | Characteristic or | | Most likely |
|---|---|---|---|---|
| Feature | Variable | Choice? | Possible Values | Features |
| Age at Start | x | Characteristic | Integer from 0 to mtea*^{A} | Integer from 45 to |
| | | | | 65 |
| Gender | — | Characteristic | male | male |
| | | | female | female |
| Health | — | Characteristic | Hearth condition, diseases history, etc . . . | |
| Status | | | | |
| Other | — | Characteristic | Employment type, marital status, etc . . . | |
| underwriting | | | | |
| Living | — | Characteristic | Smoking, drinking, etc . . . | |
| Habits | | | | |
| Asset Mix | — | Choice | Depends on provider | A to F |
| | | | Good mix of fixed income, | |
| | | | equity and real estate. | |
| | | | Example: | |
| | | | A: 100% Fixed Income, 0% | |
| | | | Equity | |
| | | | B: 80% Fixed Income, 20% | |
| | | | Equity | |
| | | | C: 60% Fixed Income, 40% | |
| | | | Equity | |
| | | | D: 40% Fixed Income, 60% | |
| | | | Equity | |
| | | | E: 20% Fixed Income, 80% | |
| | | | Equity | |
| | | | F: 0% Fixed Income, 100% | |
| | | | Equity | |
| Distribution | x + k | Choice | Integer from 0 to mtea*^{B} | Integer divisible by |
| Age | | | | 5 from 60 to 80*^{C}*^{D} |
| Surrender | sc | Choice | 0 to 100% | 0%, 25%, 100% |
| Charge | | | | |
| Death | dc | Choice | 0 to 100% | 0%, 10%, 100% |
| Charge | | | | |
| Certain | n | Choice | 0 to mtea − (x + k) | Integer divisible by |
| Period | | | | 5 from 0 to 15*^{E} |
| Cushion | α, β | Choice | Initial (α): 0% to less than | α: 20% |
| Account | | | 100% | β: 1% |
| | | | Grade Down (β): more than | |
| | | | 0% to Initial | |
| Forced | mp, | Choice | Participants (mp): more than 1 | mp: 10 in a group |
| Maturity | ma | | to less than P₀. | of more than 100, 4 |
| | | | Age (ma): more than start | in a group of 100 or |
| | | | distribution age. | less. |
| | | | | ma: 90 years old. |

*^{A}mtea: mortality table end age, typically 120.
*^{B}Early possible values are could serve the purpose of unusual arrangements such as school trustee funds.
*^{C}Later ages are also possible as the last survivor of a group may wish to join a new group.
*^{D}In order to increase pool sizes, pre-set distribution age are reasonable. Individuals can diversify this variable at an early age.
*^{E}A certain period beyond 15 years may defeats the retirement purpose, but could serve another purpose.

It will be appreciated that numerous variations of the present invention are contemplated as being within the spirit of the general concepts outlined, whether in the field of retirement planning or in other applications, for example:
Survival Sharing in its pure structure applies to any individual seeking to reduces longevity risk. Variations of the concept exist; Survival Sharing can be structured in a way that groups several individuals of different mortality distributions where each individual contributes an amount that is actuarially equivalent to other members of the group, or an equity portion of the group is allocated to the individual in an actuarially fair way. While such a structure loses some pureness elements of Survival Sharing concept, it could be very beneficial in various situations.
   For example, a group of construction workers building an apartment complex could enter into a Survival Sharing agreement where each member contributes a dollar amount and commits to a predefined number of hours of labor towards the project. An equity allocation structure could then be established utilizing both the individual contribution and mortality data. The building of the apartment complex might constitute the accumulation phase, with units in the complex being sold and/or rented during the distribution phase. The income generated could then be redistributed among survivors according to each equity share. This can result in a great alignment of interest and a very efficient way to build a retirement on core expertise. This type of structure can apply to many business entities; partnership agreements (professional firms, law firms, marketing agencies etc.) are readily adaptable to this form of arrangement. Old partners can contribute their shares of the firm to a Survival Sharing pool. Shares are progressively sold to younger partners, converted to cash and used to generate retirement income for older partners.
   Further, Survival Sharing arrangements could be applied to completely different contexts such as high education; a pool could be formed among children where parents or grand-parents contribute a certain amount to a fund growing at a certain rate of return. Funds are redistributed and can be used solely for college tuition. That way, funds from children not ultimately progressing to college (whether by virtue of death, incapacity, inability or lack of interest etc.) subsidize the ones who do attend college. The living/death triggering event is switched to an attendance/no attendance event.

Calculation Details:

This section presents a discrete mathematical illustration model of Survival Sharing. In this example:
0
   Distributions are made yearly
   Deaths and surrenders in the accumulation period occur at the beginning of the period for illustration purposes
   x=45
   k=20
   x+k=65
   ma=120
   n=0
1
   a

F₀=P₀*I
10 participants*10,000$ per participants=100,000$
b

Fₘ=F₀*(1+r)^{m}
Assuming r is constant and net of fees
100,000$*(1+4.6880235%)²⁰=250,000$
c
   Fₜ=(Fₜ₋₁−ΣDVₜ₋₁−ΣSVₜ₋₁)*(1+i)*(1−fa)
2

$${D}_{t} = \frac{{F}_{t} * [ 1 - max ( α - ( t - k ) * β , 0 ) ] \text{/} {P}_{t}}{{\ddot{a}}_{x + t}}$$

a: t=20, P₂₀=10
   (250,000$/11.6406)/10 members=2,147.66$ per member
b: t=21, P₂₁=10
   (239,237$/11.3144)/10 members=2,114.44$ per member
c: t=21, P₂₁=9
   (239,237$/11.3144)/9 members=2,349.38$ per member
3

Fₜ=(Fₜ₋₁−Pₜ₋₁*Dₜ₋₁)*(1+*(1−fd)
(250,000$—10 members*2,147.66$ per member)*(1+4.6880235%)*(1−0.00)=239,237$
Legend
   Time
      t: Time variable
      dⱼ: Elapsed time between beginning of contribution period to contribution moment of member j
      L: Contribution period length
      k: Accumulation length
      ma: Maturity Age
      n: Certain period
      q: moment when second to last member dies
   Age
      x: Age at start of accumulation period
      x+k: Age at start of distribution period
   Charges (A charge is an amount paid by a participant to the remainder of the group (in contrast to a fee).)
      dc: Death Charge (in %)
      sc: Surrender Charge (in %)
      DV: Death Value (in $)
      SV: Surrender Value (in $)
   Fee (A fee is an amount paid by the pod to the provider (in contrast to a charge).)
      fa: Fee incurred during the Accumulation period (may also be time dependent)
      fd: Fee incurred during the Distribution period (may also be time dependent)
   Contribution Cash Flows
      I: Initial Individual Investment
      u: Unit amount required for participation in a pod
      muₜ: Market price of a unit at time=t
   Payment and Fund Value
      Dₜ: Distribution payment per member at time=t
      Fₜ: Fund Value at time=t
   Participants
      Pₜ: Number of Participants alive at time=t
      mp: Maturity Participants
   Actuarial Assumptions
      i: Earned Rate (may also be time dependent)
      r: Earned Rate, net of fees (may also be time dependent)
      äₓ₊ₜ: Life Annuity factor at age=x+t
         Mortality: 2001 CSO ultimate male nonsmoker
         i: 4.6880235%
         r: i−fd−i*fd
General

| Feature | Accumulation Phase (t < k) | Distribution Phase (t >= k) |
|---|---|---|
| Death Value | DVₜ = Fₜ₋₁ * (1 − dc)/Pₜ₋₁ | DVₜ = 0 |
| Surrender | SVₜ = Fₜ₋₁ * (1 − sc)/Pₜ₋₁ | SVₜ = 0 |
| Value | | |
| Fund Value | F₀ = P₀ * I | Fₜ = (Fₜ₋₁ − Pₜ₋₁ * Dₜ₋₁) * (1 + i) * (1 − fd) |
| | Fₜ = (Fₜ₋₁ − ΣDVₜ − ΣSVₜ) * (1 + i) * (1 − fa) | |
| | Fₜ = F₀ * (1 + r)^{t} | |
| Distribution | Dₜ = 0 | No certain period: |
| | | Dₜ = (Fpₜ/äₓ₊ₜ)/Pₜ |
| | | n year certain period: |
| | | t <= k + n: |
| | | Dₜ = [Fpₖ/(ä_{n cert.} + ₙPₓ₊ₖ * vⁿ * äₓ₊ₖ₊ₙ)]/ |
| | | Pₖ |
| | | t > k + n: |
| | | Dₜ = (Fpₜ/äₓ₊ₜ)/Pₜ |
| | | Age ma maturity: |
| | | if t + k = ma: |
| | | Each Pₜ get Fₜ/Pₜ |
| | | Participant mp maturity: |
| | | if Pₜ = mp: |
| | | Each Pₜ get Fₜ/Pₜ |
| | | annuity factors use r. |
| Earned Rate | r = i − fa − i * fa | r = i − fd − i * fd |
| (assuming | | |
| variable fee | | |
| structure) | | |
| Fee | feeₜ: dollar amount fee paid at t. | feeₜ: dollar amount fee paid at t. |
| | fa: fee as % of fund value | fd: fee as % of fund value |
| | [symbol] Fixed: | [symbol] Fixed: |
| | feeₜ = fa * F₀ | feeₜ = fd * F₀ |
| | [symbol] Variable: | [symbol] Variable: |
| | feeₜ = fa * Fₜ | feeₜ = fd * Fₜ |

There are numerous differences between the present invention and presently available retirement vehicles.

Survival Sharing differs from a DB pension plan or life guarantee products which are vehicles locking in a periodic payment. By guaranteeing a payment, one party has to assume the liability. In the case of a DB plan, the corporate sponsor guarantees life contingent payments for its employees at a certain point in time: this liability needs to be funded. Similarly, insurance companies guarantee life contingent payments to their policyholders: this liability needs to be held in a reserve for this purpose. This guaranteed payment may sound comforting at first, but, as discussed earlier, funding and reserving come at a steep cost.

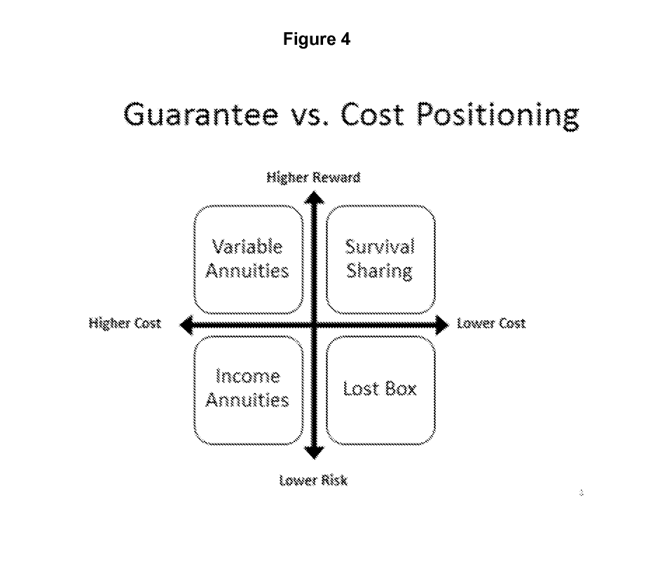

In contrast, Survival Sharing does not lock in a fixed payment and does not incur any liability. It pools investments of homogeneous investors together and redistributes the fund in the smoothest possible way to survivors in a periodic manner. Survival Sharing transfers the longevity risk to the pod of participants. The cost from the provider's perspective is therefore significantly reduced and translates into an expected benefits increase for the investors. Similar to variable annuities, Survival Sharing offers different possible mixes of assets, enabling a higher risk reward option. Survival Sharing's positioning is illustrated in FIG. 4.

Compared to many insurance products, Survival Sharing is more fairly manageable. Features are generally negotiated virtually and anonymously between each member of a group, as opposed to incurring a charge or a penalty for a particular option. This virtual negotiation takes the shape of a supply and demand mechanism, so individuals do not actually meet and negotiate in a traditional manner. If pools with a certain feature (e.g. high surrender charge) are sought out more than others, in time they will become more readily available. Investors who prefer other features may be forced to compromise on their preferences or on group sizes, but these features will be shared among individuals and not structured in a fee or penalty as they are for insurance products. For example, a deferred annuity charging a high surrender charge should generate a higher return in comparison to another annuity charging a smaller surrender charge, all else being equal. This is often difficult to measure, predict or compare. With Survival Sharing, an individual can pick and choose its group and features, as long as personal characteristics are met and other people want to be in the same group. The cost and option of each of those features are relative to the group and the individual can always be on both sides of the equation. For example, an individual can choose to be in a group with a 20% surrender charge in the accumulation phase. This means that if the individual withdraws his/her money from the fund during the accumulation period, he/she will only get 80% of the market value of their share. This feature may be seen as a large penalty in case of withdrawal, but it also serves as a protection for the investor. Unlike insurance products, the feature is not negotiated between an individual and a sophisticated financial institution, but rather between the prospective members of a pod. This introduces a cutting edge dynamic where the provider of Survival Sharing has the best incentive to group the right individuals together, as opposed to usual long and costly process.

Survival Sharing allows for group-fitting. Individuals suffering from certain medical conditions may have lower life expectancies than others and see income annuities as an undesirable option. However, these individuals still face longevity risk. With Survival Sharing they can form their own group and generate fair distributions amongst themselves.

The burden of disclosing more information about one's health is to the benefit of the investor, as the more they disclose, the more likely they are to be pooled in an advantageous group.

Advantages of the present invention include:
For Individuals
   Effective for managing longevity risk
      Longevity risk requires a grouping mechanism (pooling, hedging, insuring etc.) in order to function. Survival Sharing introduces an innovative way for individuals to manage longevity risk on their own. Further, by using Survival Sharing, one can be in a better position to control the desired bequest amount and create an estate that depends less on how long he/she will live.
      Survival Sharing may also be attractive when analyzing the added risk assumed by the investor relative to the added return generated for an individual already facing investment risk; the increase in volatility in the position taken by assuming some longevity risk is less than the increase in return, all else being equal since longevity risk is uncorrelated to investment risk.
   Cost-effective
      Since Survival Sharing does not secure a guarantee, many costs associated with the said guarantee are saved and, consequently, passed back to the investor. Sabin, for example, estimates “that insurers typically charge a premium that is 14% higher than fair.” Sabin uses the word “fair” in a statistical way where the 14% represents the bias between what the insurer is charging for contract and the purely statistical position the insurer is assuming on the same contract; the 14% difference is essentially a load for profit and expenses, which is ultimately paid by policyholders.
      FIG. 3 compares an income annuity to a Survival Sharing pod that are both free of loads (expenses, profits, etc.). The expenses incurred by the Survival Sharing pool would be lower than the expenses incurred for the income annuity. This difference would create distance between the categories, resulting in a gain for consumers opting for Survival Sharing.
   Suitable for a significant portion of the population
      Survival Sharing is a product that is suitable for individuals possessing a significant portion of their assets in non-life income vehicles.
   Accessible at a fair price for all
      Traditional guaranteed income products are often priced for healthy lives. As discussed, very few carriers offer impaired annuities for individuals in poor health. Since longevity risk is a concern for all, Survival Sharing allows formation of groups of similar health, making it fair among participants.
      Furthermore, Survival Sharing rewards participants for disclosure, thus further reducing the cost of underwriting.
   Tailored and user-defined
      Survival Sharing enables a fair, dynamic and flexible feature-selection process. Each feature is ultimately shared equivalently between individuals and each group member can participate on either side of the equation.
   Consistent Rules and Bylaws
      Survival Sharing distribution payments may vary through time, but the bylaws dictating those payments remain consistent, transparent and uniform through each contract. Traditional insurance products are often subject to modifications and fine-print disclaimers. Because all major decisions in the Survival Sharing model are negotiated anonymously within the group, any fear of provider manipulation is removed from the equation.
   Removes all or nothing amount dilemma
      Annuities are usually sold in large premium amounts which add to the daunting experience of their purchase. Survival Sharing allows smaller installments to individuals, making it smoother and allowing the buyer to become familiar with the product before making a larger commitment.
   Removes all or nothing longevity risk
      Individuals currently face two choices when dealing with longevity risk: lock into an income annuity or shoulder the full risk. Survival Sharing offers a balance between the two extremes. With Survival Sharing, one can now generate lifetime income and control their estate planning without worrying about their unknown date of death.
   Flexible to the risk appetite of the individual
      Survival Sharing enables individuals the flexibility to take on more risks with their savings, hence potentially generating higher returns in the long run.
   Natural long-term care and medical costs hedge
      As individuals live longer, health care and long-term care costs are likely to increase. Survival Sharing is not meant to be a substitute for long-term care, health or disability insurance, but does provide income at a critical time for certain individuals.
   Effective for hedging interest risk
      Large interest rate swings can have a huge impact on income revenues. Survival Sharing deploys capital progressively over a lifespan, and thereby smoothens the process.
   No provider default risk
      Although rare, insurer default is not impossible. Survival Sharing limits default risk to the asset exposure desired.
   Empowers and encourages decision making from a position of strength
      In the past, retirees have often had to wrestle with tough decisions at a time when it was least convenient and judgment could be heavily compromised. Survival Sharing enables more individuals to make informed decisions while they are still in a position of strength, confidence and security.
For Society:
   Provides a financial incentive to stay healthy
      Survival Sharing incentivizes individuals to make healthy choices, since the longer they live, the greater their financial benefit.
   Reduces intergenerational conflicts
      With Survival Sharing, no segment of society is on the hook. Each group is self-sustainable and assets are redistributed by an independent party. Any deviation from the expected is reassessed each year. As a result, a potentially contentious political issue is now diffused.
   Addresses growing concern of longevity risk
      Longevity risk is no longer a fringe issue for many organizations. The American Academy of Actuaries has put together the “Lifetime Income Risk Task Force” in order “to address the risks and related issues of inadequate lifetime income among retirees”. Similarly, The International Monetary Fund dedicated a whole chapter to “The Financial Impact of Longevity Risk”. As lifespans increase, longevity risk will be a growing topic of interest and concern for a wide spectrum of organizations.
   Increases distribution channels for retirement products
      To date, the Internet sales of annuity products have not matched the comparable expected levels of other societal goods and services. Survival Sharing is designed to be accessible in a fashion that suits customers of the 21^{st} century.
   Decreases governmental role in issues of retirement
      In the past, individuals have often taken for granted a magical age of retirement (e.g., age 65). This has often created political conflict, especially at times when governmental solvency has been turbulent. Survival Sharing shifts the timing vs. reward dilemma choice to each individual and thus reduces a significant layer of politics and the need to explain possible unpopular decisions (e.g., increasing the retirement age to ensure pension fund solvency). Survival Sharing also increases societal awareness of the multiple entities and how they interact.
   Reduces need for outside regulation
      Since many features of Survival Sharing are negotiated (virtually) among the pod members, the need for outside regulation is decreased (i.e. mandating features such as surrender charges would not necessarily protect consumers). Survival Sharing's group model empowers members of the pool to regulate themselves on many issues.
   Empowers and educates society about retirement planning
      Survival Sharing empowers each user to play a hands-on role in their retirement planning and make decisions regarding ideal retirement age and target accumulation. A society that is better educated on the aspects of retirement planning is likely to be more financially stable, positive and productive.

It is believed Survival Sharing positions itself distinctly by offering a product that allows investors to keep more of their invested funds, while significantly decreasing their longevity risk. Survival Sharing is designed to be bought progressively, as opposed to an all or nothing product. This allows individuals to slowly build their retirement portfolio with shares in other additional groups over the years and become familiar with Survival Sharing and its features while diversifying investments returns and mortality risks along the way. Survival Sharing can also supplement other forms of retirement vehicles.

### Additional General Statements

Reference is made in this specification to the application of computers, computer implemented systems and computerized modules, that may be used in accordance with the method and system of the embodiments of the present invention and as applied in some example embodiments. It should be appreciated that a set of instructions may be executed, for causing such machines, systems and/or modules to perform any one or more of the methodologies discussed above. The machine may operate as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine may be described, a single machine shall also be taken to include any collection of machines that individually or jointly execute a set (or multiple sets) of instructions to perform any one or more of the methodologies or functions described in this specification.

Machine-readable media may be provided, on which is stored one or more sets of instructions (e.g., software, firmware, or a combination thereof) embodying any one or more of the methodologies or functions described in this specification. The instructions may also reside, completely or at least partially, within the main memory, the static memory, and/or within the processor during execution thereof by the computer system. The instructions may further be transmitted or received over a network via the network interface device.

In example embodiments, a computer system (e.g., a standalone, client or server computer system) configured by an application may constitute a “module” that is configured and operates to perform certain operations. In other embodiments, the “module” may be implemented mechanically or electronically; so a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies or functions in the present description. The term “machine-readable medium” shall accordingly be taken to include, but not be limited to, solid-state memories, and optical and magnetic media.

1. A method for distributing an income stream of payments to a group of participant individuals for an indefinite period associated with the longevity of the participants, the method comprising:
providing one or more computers or one or more computer servers, the one or more computers or one or more computer servers having a processor and memory storage with instructions which when executed by the processor perform predetermined functions;
providing a database stored on the memory storage of the at least one or more computers or one or more computer servers;
in an establishment function phase:
collecting information for storage in the database relating to a plurality of potential participants, the information including mortality criteria;
identifying, by the one or more computers or one or more computer servers, from the information collected, common mortality criteria and/or common expected mortality calculated from some or all of the mortality criteria relating to some or all of the potential participants indicating a substantially equivalent mortality risk;
defining, by the one or more computers or one or more computer servers, from some or all the identified common mortality criteria and/or the common expected mortality, requirements for inclusion of potential participants in one or more substantially homogeneous mortality risk groups;
identifying, by the one or more computers or one or more computer servers, a plurality of participants having a substantially equivalent mortality risk as determined by meeting the requirements for inclusion in the one or more groups;
forming one or more groups of some or all of the identified participants, the matching of the participant in any group being selected by the participant or on behalf of the participant;
establishing a group investment fund, the investment fund being the aggregation of investment payments received from or on behalf of each participant in the group;
investing some or all of the investment fund in an asset allocation portfolio in accordance with predetermined investment guidelines intended to grow the investment fund; and
in a distribution phase:
distributing a portion of the investment fund as payments at predetermined distribution periods, the portion being made available for distribution payments at the completion of any period being calculated according to a predefined actuarially fair calculation agreed between the participants;
wherein some or all of the longevity risk is transferred to the group of participants and an income stream of payments to the participants is made available for as long as they live or until there is only a predetermined number of survivors remaining from the original group or where a predefined time has elapsed after formation of the group or after the occurrence of another predefined circumstance.

2. The method of claim 1, wherein the mortality criteria relates to the potential participants' age, gender and health condition.

3. The method of claim 1, wherein the mortality criteria relates to the potential participants' age, gender and health condition and additionally includes criteria considered relevant to expected mortality, including living habits and type of employment.

4. The method of claim 1, further comprising an accumulation phase, wherein the asset allocation portfolio is invested for a predetermined accumulation period prior to the initiation of the distribution phase.

5. The method of claim 1, further comprising an accumulation phase, wherein the asset allocation portfolio is invested for a predetermined accumulation period prior to the initiation of the distribution phase and the participants are afforded the right to leave the group voluntarily at any time during the accumulation phase.

6. The method of claim 1, further comprising an accumulation phase, wherein the asset allocation portfolio is invested for a predetermined accumulation period prior to the initiation of the distribution phase, and wherein in the distribution phase payments are made only to any surviving participants remaining or, where the participants have agreed in advance, that the payments be made to survivors and to beneficiaries of survivors for a predetermined initial period after the accumulation period.

7. The method of claim 1, wherein the predefined actuarially fair calculation accounts for variations in the investment results achieved, in anticipated future investment returns, in the group's mortality experience and in expected future mortality risk.

8. The method of claim 1, wherein the income stream of payments is made after the effluxion of predefined time, the time being determined based on the age of the group or the period since group formation.

9. The method of claim 1, wherein a cushion account is provided as a side fund buffer allocated within the investment fund from which distribution payments are not initially withdrawn, being designed to lower the risk of decreased future distribution payments.

10. The method of claim 1, wherein a cushion account is provided as a side fund buffer allocated within the investment fund from which distribution payments are not initially withdrawn, being designed to lower the risk of decreased future distribution payments, wherein the buffer held in the cushion account is reduced over time until a predetermined period is completed since group formation or after predefined circumstances have reduced in effect; whereafter more of the buffer becomes available for distribution over time.

11. The method of claim 1, wherein investment fees are deducted from the funds available in the investment fund, or deducted in whole or in part from the payments made to the participants.

12. A system for the provision of a stream of payments to a group of participant individuals for an indefinite period associated with the longevity of the participants, the system comprising:
one or more computers or one or more computer servers, the one or more computers or one or more computer servers having a processor and memory storage with instructions which when executed by the processor perform predetermined functions;
a database stored on the memory storage of the at least one or more computers or one or more computer servers;
an information receiving function module, operable to receive information on the database relating to a plurality of potential participants, the information including mortality criteria, the database identifying common mortality criteria and/or common expected mortality calculated from some or all of the mortality criteria relating to some or all of the potential participants thereby indicating a substantially equivalent mortality risk;
a mortality assessment function module, performed by the one or more computers or one or more computer servers, and defining, from some or all the identified common mortality criteria and/or the common expected mortality, requirements for inclusion of potential participants in one or more substantially homogeneous mortality risk groups and thereby operable to identify a plurality of participants having a substantially equivalent mortality risk as determined by meeting the requirements for inclusion in the one or more groups;
a group formation function module, operable to form one or more groups from some or all of the identified participants, the matching of the participant in any group being operable to be selected by the participant or on behalf of the participant;
an investment module, operable to form a group investment fund funded with the aggregation of investment payments received from or on behalf of each participant in the group and operable to invest some or all of the investment fund in an asset allocation portfolio in accordance with predetermined investment guidelines intended to grow the investment fund; and
a distribution module, operable to distribute a portion of the investment fund as payments at predetermined distribution periods, the portion being made available for distribution payments at the completion of any period being calculated according to a predefined actuarially fair calculation agreed between the participants;
wherein in operation some or all of the longevity risk is operable to be transferred to the group of participants and an income stream of payments to the participants is made available for as long as they live or until there is only a predetermined number of survivors remaining from the original group or where a predefined time has elapsed after formation of the group or after the occurrence of another predefined circumstance.

13. A non-transitory computer-readable medium having stored thereon instructions which, when executed by one or more computers or one or more computer servers, cause the one or more computers or one or more computer servers to perform operations to implement the distribution of an income stream of payments to a group of participant individuals for an indefinite period associated with the longevity of the participants, the operations to implement the distribution of an income stream of payments comprising:
an information collection operation relating to the information associated with a plurality of potential participants, the information including mortality criteria;
an identification operation, from the information collected, that identifies common mortality criteria and/or common expected mortality calculated from some or all of the mortality criteria relating to some or all of the potential participants indicating a substantially equivalent mortality risk;
a definition operation, that defines, from some or all the identified common mortality criteria and/or the common expected mortality, requirements for inclusion of potential participants in one or more substantially homogeneous mortality risk groups;
an identification operation, identifies a plurality of participants having a substantially equivalent mortality risk as determined by meeting the requirements for inclusion in the one or more groups;
a group formation operation, that forms one or more groups of some or all of the identified participants, the matching of the participant in any group being selected by the participant or on behalf of the participant;
an investment operation, that establishes a group investment fund, the investment fund being the aggregation of investment payments received from or on behalf of each participant in the group;
an investment operation, that invests some or all of the investment fund in an asset allocation portfolio in accordance with predetermined investment guidelines intended to grow the investment fund; and
a distribution operation, that distributes a portion of the investment fund as payments at predetermined distribution periods, the portion being made available for distribution payments at the completion of any period being calculated according to a predefined actuarially fair calculation agreed between the participants;
wherein some or all of the longevity risk is transferred to the group of participants and an income stream of payments to the participants is made available for as long as they live or until there is only a predetermined number of survivors remaining from the original group or where a predefined time has elapsed after formation of the group or after the occurrence of another predefined circumstance.
